(19) United States
(12) Patent Application Publication
(10) Pub. No.: US 2003/0163746 A1
(43) Pub. Date: Aug. 28, 2003

(54) Power-saving method for an optical disc drive

(76) Inventor: Yi-Chung Lee, Hsinchu (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/252,202

(22) Filed: Sep. 23, 2002

(30) Foreign Application Priority Data
Feb. 22, 2002 (TW) 91103222

(51) Int. Cl. G06F 1/32

(52) U.S. Cl. 713/320

(57) ABSTRACT

A power-saving method for a CD/DVD drive. When the CD/DVD drive is idle for a period of time, the drive will enter a power-saving mode. In addition, micro-controller unit (MCU) will enter a power-down mode and needs least of power consumption. Whenever CD/DVD drive receives a command from the host computer, the drive restores to a normal mode in a short period. In this light, the power consumption of CD/DVD drive using the power-saving method is optimized.

### BACKGROUND OF THE INVENTION

1. Field of the Invention

The invention relates to a power-saving method for an optical disc drive, and more particularly, to a method capable of optimizing power consumption by applying a power down mode to a micro-control unit (MCU) when not operating.

2. Description of Related Art

Generally, achieving power-saving function for a device with an MCU essentially has an idle mode and a power down mode. When the MCU is in the idle mode and its operation will stop even though other devices (such as oscillator, timer, serial interrupt unit and the like) connected to the MCU are operating. An operating current of the MCU in the idle mode is around 1 mA.

The power-down mode stops the oscillator such that the MCU completely pauses. The operating current of the MCU in the power-down mode is approximately 10 μA.

An optical disc drive, such as CD or DVD drive, connected to the MCU, will enter an idle mode from a normal mode when no operation occurs for a set period. At this point, the MCU pauses and cannot function. To restore the MCU to the normal mode, the conventional methods use a power switching process. As cited, the required operating current in the idle mode is between 200 and 400 μA even though a power-saving means is implemented. This consumes much more power.

### SUMMARY OF THE INVENTION

Accordingly, an object of the invention is to provide a method capable of optimizing power consumption by applying a power down mode to a micro-control unit (MCU) when not operating.

The invention provides a method capable of optimizing power consumption on the MCU without affecting the normal operation of an optical disc drive. The method first determines if, for the MCU in a normal mode, a host computer connected to a spindle motor does not send a command for a period of time after the spindle motor of the optical disc drive stops. If the result is “yes”, a power-down mode is activated to force the MCU into the power-down mode until the MCU receives the command from the host computer. As such, a decoder of the optical disc drive uses an interrupt instruction (INT) to wake up the MCU in order to fetch the code with respect to the command and perform the corresponding function. At this point, the MCU returns to its normal mode. Accordingly, the required power is reduced and the performance of the optical disc drive is optimized.

### BRIEF DESCRIPTION OF THE DRAWINGS

FIG. 1 is a schematic illustrating primary elements of the present invention; and

FIG. 2 is a flowchart of a method according to the present invention.

### DETAILED DESCRIPTION OF THE INVENTION

The following detailed description is of the best presently contemplated modes of carrying out the invention. This description is not taken in a limiting sense, but is made merely for the purpose of illustrating general principles of embodiments of the invention. The scope of the invention is best defined by the appended claims.

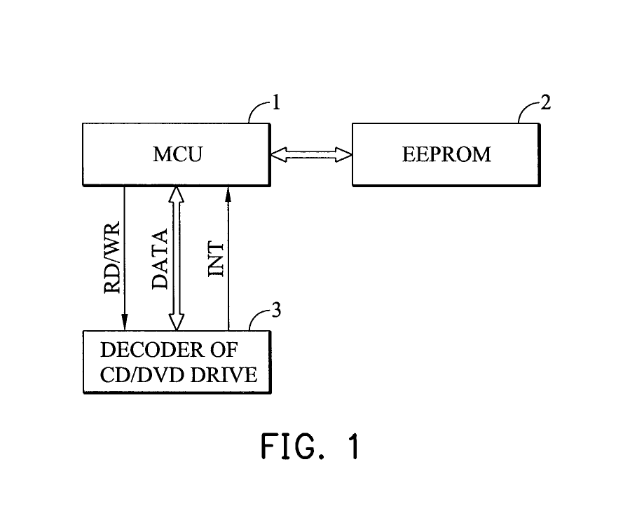

FIG. 1 is a schematic illustrating the relationship between a micro-control unit (MCU) and an optical disc drive according to the present invention. As shown in FIG. 1, the MCU 1 is connected to a decoder 3 of a CD or a DVD drive and an EEPROM 2. The decoder 3 is connected to pins RD/WR, DATA, and INT of the MCU 1.

The MCU 1 controls all operations of the decoder 3 through the pins RD/WR, DATA, and INT according to an instruction from the EEPROM 2.

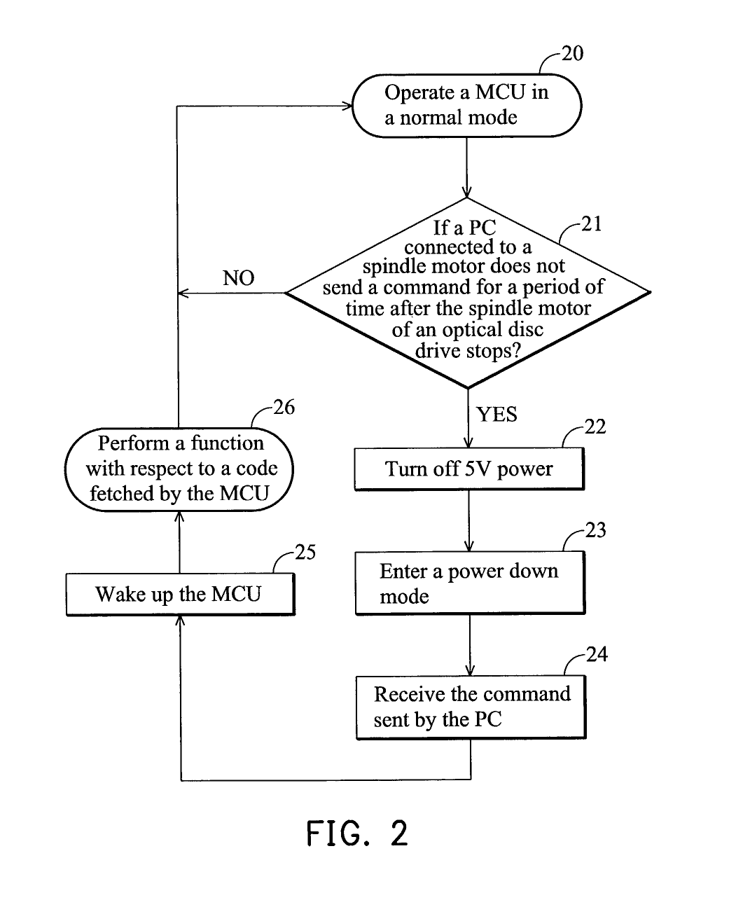

FIG. 2 is a flowchart of a method according to the present invention.

Step 20: In this step, the MCU 1 is initially in a normal mode (20) as shown in FIG. 2.

Step 21: In this step it is determined whether a host computer connected to a spindle motor does not send a command in 40 ms after the spindle motor of the CD/DVD drive stops. If yes, this means the host computer does not send a command and MCU 1 is idle for a period of time. Processing then proceeds to step 22. If no, MCU is activated by the host computer and processing returns to step 20.

Step 22: In this step, after MCU 1 is idle for a period of time, a control chipset performs a power-down procedure to turn off 5V power connected to the drive. Processing proceeds to step 23.

Step 23: In this step, the MCU 1 enters a power-down mode because the power connected to the CD/DVD drive is turned off. Processing proceeds to step 24.

Step 24: In this step, the MCU 1 receives the command from the host computer when MCU 1 is in the power-down mode. MCU 1 pauses unless the host command is received. Processing proceeds to step 25.

Step 25: In this step, the decoder 3 sends an interrupt instruction through the pin INT to wake up the MCU 1after MCU 1 receives the command from the host computer. Processing proceeds to step 26.

Step 26: In this step, the MCU 1 fetches the code to perform the corresponding function with respect to the command, and processing then returns to step 20.

Accordingly repeated, consumption of the required power is reduced and the performance of the drive is thus optimized.

In summary, the drive can provide the optimal power consumption using the inventive method and corresponding software program such that industrial utility is met.

These modifications can be made to the invention in light of the above detailed description. The terms used in the following claims should not be construed to limit the invention to the specific embodiment disclosed in the specification and the claims. Rather, the scope of the invention is to be determined entirely by the following claims, which are to be construed in accordance with established doctrines of claim interpretation.

What is claimed is:

1. A power-saving method for an optical disc drive, comprising:
(a) operating a MCU in a normal mode;
(b) determining if a host computer connected to a spindle motor of the optical disc drive does not send a command for a period of time after the spindle motor stops;
(c) performing a power down operation to apply a power down mode to the MCU if the host computer does not send the command for the period of time;
(d) waking up the MCU when the MCU receives the command sent by the host computer;
(e) performing a function with respect to a code fetched by the MCU and returning to step (a), thereby repeating the steps to achieve an optimal power consumption reduction.

2. The power-saving method of claim 1, wherein the period of time is 40 ms.

3. The power-saving method of claim 1, wherein the processing in step (b) returns to step (a) directly if the spindle motor continues spinning or the PC sends the command.

4. The power-saving method of claim 1, wherein the power-down operation turns off 5V power provided by the host computer to the optical disc drive in step (c).

5. The power-saving method of claim 1, wherein a decoder of the optical disc drive sends an interrupt instruction (INT) to wake up the MCU when the MCU receives the command sent by the host computer in step (d).
